(19) United States
(12) Patent Application Publication
(10) Pub. No.: US 2020/0325981 A1
(43) Pub. Date: Oct. 15, 2020

(54) Planetary carrier arrangement of a planetary gear, in particular a planetary gear of a side door drive, as well as a method for the manufacture of such a planetary carrier arrangement

(71) Applicant: IMS GEAR SE & Co. KGaA, Donaueschingen (DE)

(72) Inventors: Matthias KOOP, Donaueschingen (DE); Manuel IRION, Talheim (DE); Bjorn Karnat, March (DE); Veronica LABRIOLA, Villingen-Schwenningen (DE)

(21) Appl. No.: 16/845,727

(22) Filed: Apr. 10, 2020

(30) Foreign Application Priority Data
Apr. 11, 2019 (DE) 102019109616.2

(51) Int. Cl. F16H 57/08; E05F 15/652; F16H 57/032

(52) U.S. Cl. CPC F16H 57/082; F16H 2025/2087; F16H 57/032; E05F 15/652

(57) ABSTRACT

A carrier arrangement of a planetary gear, in particular a planetary gear of a side door drive, includes a planetary carrier, preferably in one-piece, with a flange that extends along a rotational axis (APT) and which is provided with a first side and a second side, at least one planetary wheel, which is retained at a distance from the pivoting axis (APT) and is pivot-mounted around a planetary wheel rotational axis (APR), wherein at least one recess is arranged between the first side and the second side, in which the at least one planetary wheel is pivotally mounted and retained by means of at least one planetary wheel axle, wherein the planetary carrier and the planetary wheel are made of plastic and the planetary wheel axle is made from steel or plastic. The disclosure relates, moreover, to a method for the manufacture of such a planetary carrier arrangement.

The present invention relates to a planetary carrier arrangement of a planetary gear, in particular a planetary gear of a side door drive, as well as a method for the manufacture of such a planetary carrier arrangement.

Side door drives are known from prior art in different embodiments, serving the automated operation of side doors, in particular a sliding door of a motor vehicle. Side door drives of this kind typically comprise a planetary gear, which provides a gear reduction for a side door drive. In this instance, the planetary gear comprises at least one planetary carrier that is arranged on a drive shaft, wherein said planetary carrier retains multiple, pivot-mounted planetary wheels that are retained at a distance from the drive shaft.

Side door drives with a planetary carrier arrangement are known from prior art, which are configured from a two-part steel planetary carrier in cage form, wherein the planetary carrier is pressed onto a drive shaft or is attached to it by means of two plastic side plates. Planetary carriers of this kind are mass-produced and have the disadvantage of being time-consuming to assemble. Planetary carrier arrangements of this kind are typically assembled from a number of different components that are then bolted or pressed together. Another disadvantage of said prior art is that there is a limit to the amount of material savings that can be achieved to reduce the weight of such a side door drive, which makes the side door drives unnecessarily heavy.

Although the above-described starting position is relevant in particular for side door drives, said starting position applies also to other applications of planetary gear arrangements. Examples for planetary gear arrangements of this kind are known from DE 10 2005 023 542 A1, DE 10 2015 119 803 A1 and WO 2014/095966 A1.

It is therefore the object of the present invention to provide a planetary gear arrangement of a planetary gear, in particular a planetary gear of a side door drive, as well as a method for the manufacture of the planetary gear arrangement, which simplifies the assembly of the planetary gear arrangement, permits a maximum in weight reduction and reduces the complexity of components to a minimum. Said object is achieved with the features described in claims 1, 3, 4, 7, 9, 10, 14, 15, 16, 17, 18 and 20. Advantageous embodiments are subject of the dependent claims.

One embodiment of the invention relates to a planetary carrier arrangement of a planetary gear, in particular a planetary gear of a side door drive, comprising
a planetary carrier, preferably in one-piece, with a flange that extends along a rotational axis and which is provided with a first side and a second side,
at least one planetary wheel, which is retained at a distance from the pivoting axis and is pivot-mounted around a planetary wheel rotational axis, wherein
at least one recess is arranged between the first side and the second side, in which the at least one planetary wheel is pivotally mounted and retained by means of at least one planetary wheel axle, wherein
the planetary carrier and the planetary wheel are made from plastic and the planetary wheel axle is made from steel.

The use of steel for the planetary wheel axle has the advantage that the planetary wheel axle can be provided with a reduced diameter and/or can be provided with a reduced amount of material but is still able to bear high loads.

According to a further embodiment, the planetary wheel axle is pressed into the planetary carrier on the first side and is caulked with the planetary carrier on the second side, or reverse.

This embodiment requires no thermal joining process. Caulking is an easily controllable and economic production step so that the fastening of the planetary wheel axle on the planetary carrier can be carried out in a comparatively simple manner.

One exemplary embodiment of the invention relates to a method for the production of a planetary carrier arrangement according to the above-described further embodiment, comprising the following steps:
placing of the at least one planetary wheel into the recess,
pressing the planetary wheel axle into the planetary carrier from the first side so that the planetary wheel axle penetrates the planetary wheel and the recess and is accessible from the second side, and
caulking of the planetary wheel axle from the second side.

The above-described technical effects can be achieved with this method. In particular it is not necessary to use a thermal joining method.

One embodiment of the invention relates to a planetary carrier arrangement of a planetary gear, in particular of a planetary gear of a side door drive, comprising
a planetary carrier, preferably in one piece, with a flange that extends along a rotational axis and which has a first side and a second side,
at least one planetary wheel, which is retained at a distance from the pivoting axis and is pivot-mounted around a planetary wheel rotational axis, wherein
at least one recess is arranged between the first side and the second side, in which the at least one planetary wheel is pivotally mounted and retained by means of at least one planetary wheel axle, and
the planetary carrier, the planetary wheel and the planetary wheel axle are made from plastic.

In contrast to the further above-described embodiment the planetary carrier arrangement of this design is made solely from plastic. The material characteristics, for example the heat expansion characteristic, are very uniform so that there are no measures required to compensate for the different material characteristics.

In a further-developed embodiment, the planetary wheel axle may be pressed on the first side into the planetary carrier and ultrasonically welded to the planetary carrier from the first side.

The assembly of the planetary carrier arrangement in this embodiment may be carried out either from the first side only or from the second side only. It is therefore not necessary to turn the planetary carrier, in particular during assembly, which not only simplifies and shortens the assembly process but also reduces the cost.

In a further-developed embodiment the planetary wheel axle may be provided with at least one locking means with which the planetary wheel axle is retained on the planetary carrier.

The utilization of locking means has the advantage of being able to attach the planetary wheel axle to the planetary carrier very quickly, reliably and simply. As soon as the planetary wheel axle is located in its final position, it is fastened to the planetary carrier. No further fastening measures are required.

According to a further exemplary embodiment, said method may comprise the following steps:
placing the at least one planetary wheel into the recess,
pressing the planetary wheel axle into the planetary carrier from the first side so that the planetary wheel axle penetrates the planetary wheel and the recess, and
ultrasonic welding of the planetary wheel axle to the planetary carrier from the first side.

This exemplary embodiment of the method has the particular advantage that the planetary carrier does not have to be turned during assembly. Further clamping may therefore be omitted. This simplifies and shortens the assembly process. Although this exemplary embodiment aims to press the planetary wheel axle into the planetary carrier from the first side and also to weld it from the first side, said method may of course also be implemented by carrying out said steps exclusively from the second side.

According to a further-developed exemplary embodiment the method may comprise the following steps:
placing the at least one planetary wheel into the recess,
pressing the planetary wheel axle into the planetary carrier from the first side so that the planetary wheel axle penetrates the planetary wheel and the recess, and
interlocking the planetary wheel axle with the planetary carrier.

As already mentioned, interlocking is a particularly simple and quick step for joining the planetary wheel axle to the planetary carrier. It is therefore possible to assemble the planetary carrier arrangement very quickly and cost-effectively.

One implementation of the invention concerns a planetary carrier arrangement of a planetary gear, in particular a planetary gear of a side door drive, comprising
a planetary carrier, preferably in one piece, with a flange that extends along a rotational axis and which has a first side and a second side,
at least one planetary wheel, which is retained at a distance from the pivoting axis and is pivot-mounted around a planetary wheel rotational axis, wherein
at least one recess is arranged between the first side and the second side, in which the at least one planetary wheel is pivotally mounted and retained by means of at least one planetary wheel axle, wherein
the planetary carrier and the planetary wheel are made from plastic,
on the first side at least a first deformation and on the second side at least a second deformation is provided, which protrude into the recess, and
the planetary wheel is retained by the first deformation and the second deformation in a pivotable manner.

The deformations may also be produced through caulking of the planetary carrier without the necessity for thermal treatment of the planetary carrier. Furthermore, a planetary wheel axle is not necessary. The deformations act as bearing pins. This reduces the number of components, and it is not necessary to carry out an energy-intensive, thermal deformation.

One implementation of the invention concerns a method for the manufacture of a planetary carrier arrangement according to the above-described implementation, comprising the following steps:
inserting the at least one planetary wheel into the recess,
developing the first deformation through deformation of the planetary carrier on the first side, and
developing the second deformation through deformation of the planetary carrier on the second side.

The stated advantages of the planetary carrier arrangement manufactured with this method apply equally to the method according to this implementation. Particular emphasis is placed upon the reduction of components as well as on the possibility of being able to omit an energy-intensive, thermal deformation.

In a further implementation of the method, the planetary carrier shows, on the first side, a first material buildup and on the second side, a second material buildup, wherein the step of forming the first deformation is carried out through deforming the planetary carrier in the vicinity of the first material buildup, and the step of forming the second deformation is carried out through deforming the planetary carrier in the vicinity of the second material buildup.

By using the material buildups it is possible to determine, and in particular increase, the wall thickness and thus the rigidity of the first and of the second deformation.

A further developed implementation of the present invention is characterized in that the planetary carrier is provided with pockets on the first side and/or on the second side into which the planetary wheels with corresponding protrusions may be placed. On assembly, it is necessary to arrange the planetary wheels concentrically to the planetary wheel axles to enable the planetary wheel axles to pass through the planetary wheels. The utilization of the pockets permits the preliminary fixing of the planetary wheels prior to the planetary wheel axles being passed through the same. This makes assembly easier.

According to a further implementation of the present invention the planetary carrier comprises a bund against which the planetary wheel axle or the planetary wheel runs up. The provision of a bund has the effect that the planetary wheel is axially fixed on the planetary wheel axle. A wear point forms on the bund since the planetary wheel rotates relative to the stationary planetary carrier. The bund may be designed such that friction and wear are minimized and the planetary wheel and the planetary carrier are not damaged due to wear.

One embodiment of the invention relates to a planetary carrier arrangement of a planetary gear, in particular a planetary gear of a side door drive, comprising
a planetary carrier, preferably in two parts, with
a flange-like cage that extends along a rotational axis, and
a cover that is attached to the cage and thereby forming a recess,
at least one planetary wheel, which is retained at a distance from the pivoting axis, wherein said planetary wheel is pivot-mounted in the recess around a planetary wheel rotational axis, wherein
the cage, the cover and the planetary wheel are made from plastic and the planetary wheel axle is made from steel.

In contrast to the above-described variations of the planetary carrier arrangement, the planetary carrier in this embodiment is made in two parts. Whilst, when assembling the planetary carrier arrangement with a one-part planetary carrier, the planetary wheels have to be inserted from the side into the recess and placed concentrically to the planetary wheel axles, with the two-part embodiment of the planetary carrier it is possible to push the planetary wheels onto the planetary wheel axles prior to attaching the cover to the cage. Since the concentric alignment prior to the insertion of the planetary wheel axle through the planetary wheel is redundant, the assembly is simpler when compared to that of a one-piece planetary carrier. Because the planetary wheel axle is made from steel, it is possible to manufacture the planetary wheel axle with a high degree of strength and a comparatively small diameter and/or with a reduced amount of material.

One embodiment of the invention relates to a method for the manufacture of a planetary carrier arrangement according to the above-described embodiment, comprising the following steps:
providing the cage through overmolding of the planetary wheel axles,
pushing the planetary wheels onto the planetary wheel axles, and
fastening the cover to the cage or to the planetary wheel axles.

As already mentioned, pushing the planetary wheels onto the planetary wheel axles is significantly simpler compared to the concentric alignment of the planetary wheels prior to the insertion of the planetary wheel axle, which makes the assembly of the two-part planetary carrier simpler.

A further development of the invention relates to a planetary carrier arrangement of a planetary gear, in particular a planetary gear of a side door drive, comprising
a planetary carrier, preferably in two parts, with
a flange-like cage that extends along a rotational axis, and
a cover fastened to the cage and thereby forming a recess,
at least one planetary wheel, which is retained at a distance from the pivoting axis and is pivot-mounted in the recess around a planetary wheel rotational axis, wherein
the cage, the cover and the planetary wheel and the planetary wheel axle are made from plastic and the planetary wheel axle is formed from the cage or from the cover.

In this further development the planetary carrier arrangement is made exclusively from plastic so that measures to compensate for different material characteristics are not necessary, which may, for example, be necessary when using steel as material for the planetary wheel axles. Moreover, in this further development provision is made that the planetary wheel axle is formed from the cage or from the cover. Thus, the planetary wheel axle does not constitute an additional component, which reduces the overall number of components.

According to a more advanced further development the method comprises the following steps:
providing the cage that forms the planetary wheel axle,
pushing the planetary wheel onto the planetary wheel axle, and
fastening the cover to the cage or to the planetary wheel axle.

With this further development of the method it is possible to manufacture the planetary carrier arrangement in a very simple manner. Due to the fact that the planetary wheel axle is formed by the cage, the step of attaching the planetary wheel axle to the cage becomes obsolete. The assembly is also made easier since there are no logistical measures required any longer for providing the planetary wheel axle. Although this further development aims to form the planetary wheel axle from the cage, the advantages apply equally if the planetary wheel axle is formed from the cover.

One embodiment of the invention relates to a planetary carrier arrangement of a planetary gear, in particular a planetary gear of a side door drive, comprising
a planetary carrier in two parts with
a flange-like cage that extends along a rotational axis, and
a cover fastened to the cage and thereby forming a recess,
at least one planetary wheel, which is retained at a distance from the pivoting axis by means of a planetary wheel axle, and is pivot-mounted in the recess around a planetary wheel rotational axis, wherein
the cage, the cover and the planetary wheel and the planetary wheel axle are made from plastic, and
the planetary wheel axle is provided with a first planetary wheel axle section formed by the cage, and a second planetary wheel axle section formed by the cover, which may be joined to each other.

In this embodiment one of the planetary wheel axle sections may be made in tubular form so that the other planetary axle section may be inserted into the tubular planetary wheel axel section. During the insertion, the cover is already positioned with respect to the cage so that the subsequent joining step can not [sic] be guided in a relatively simple manner.

A further embodiment is characterized in that the cage consists of a first plastic material and the cover consists of a second plastic material.

In this embodiment it is possible to choose the plastic material that comes into contact with the planetary wheel so that it has good gliding characteristics. The plastic material that does not come into contact with the planetary wheel may have particularly high rigidity, where said plastic material may be fiber reinforced, for example. This means that with this method it is possible to achieve high rigidity on the one hand and good gliding characteristics on the other hand.

A further embodiment of the invention relates to a method for the manufacture of a planetary carrier arrangement according to any one of the above-described designs, comprising the following steps:
providing the cage that forms the first planetary wheel axle section,
providing the cover that forms the second planetary wheel axle section,
joining of the first planetary wheel axle section and the second planetary wheel axle section,
pushing the planetary wheels onto the first planetary wheel axle section or onto the second planetary wheel axle section, and
fastening the cover to the cage or to the planetary wheel axles.

As already described, when joining the two planetary wheel axle sections, the cover and the cage are positioned to each other so that the subsequent fastening steps can be carried out in a relatively simple manner.

According to a further developed embodiment, the cover, the cage and/or the planetary wheel axles are provided with locking means with which the cover is fastened to the planetary wheel axles or to the cage through interlocking.

As also mentioned earlier, interlocking is a particularly simple and quick joining step.

A further-developed embodiment is characterized in that the cover is fastened to the planetary wheel axles or to the cage by means of ultrasonic welding. Welding times are very short, which means that the ultrasonic welding can be carried out very economically. The joining members are only slightly heated up in the welding area, and the surrounding material is not damaged.

Exemplary embodiments of the invention are described below in greater detail with reference to the attached drawings. Shown are in:

FIG. 1 a perspective representation of a planetary carrier arrangement with a planetary carrier,

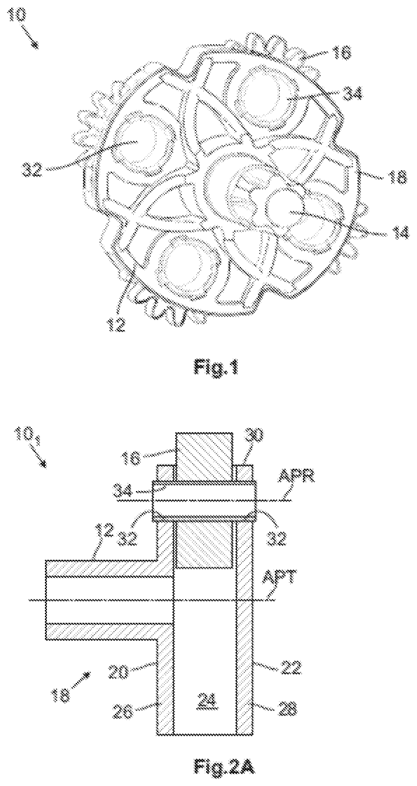

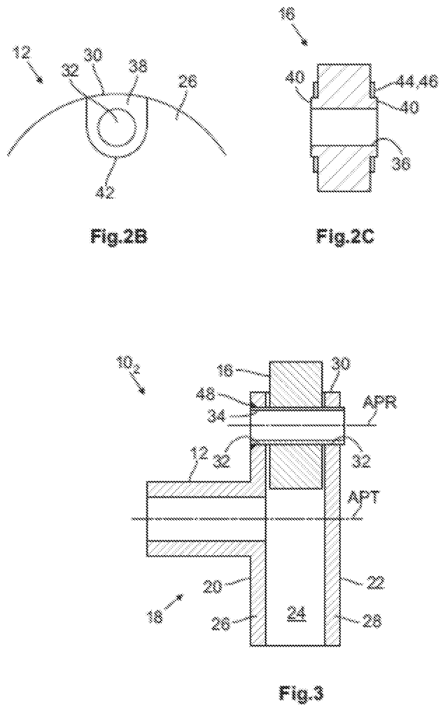

FIG. 2A a first exemplary embodiment of a planetary carrier arrangement according to the invention by way of a cross-section approximately defined in FIG. 1,

FIG. 2B a partial side view along the rotational axis onto the planetary carrier, seen from the direction of the recess,

FIG. 2C an isolated side view of a planetary wheel,

FIG. 3 a second exemplary embodiment of a planetary carrier arrangement according to the invention,

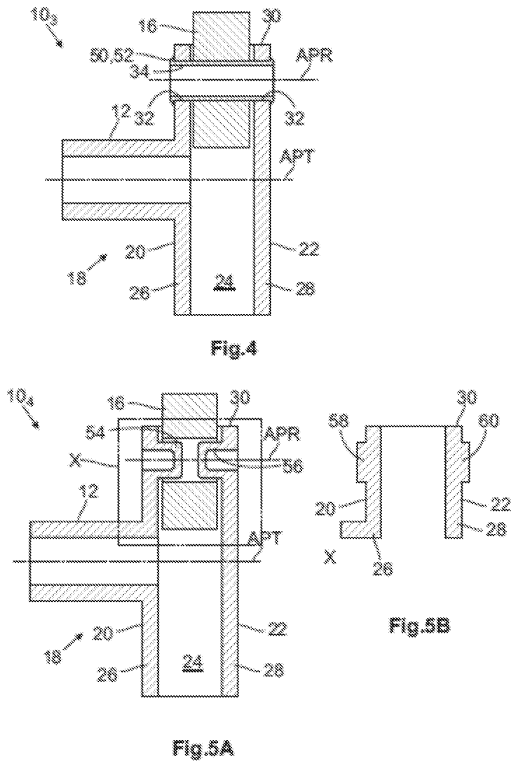

FIG. 4 a third exemplary embodiment of a planetary carrier arrangement according to the invention,

FIG. 5A a fourth exemplary embodiment of a planetary carrier arrangement according to the invention,

FIG. 5B an isolated representation of section X marked in FIG. 5A without planetary wheel,

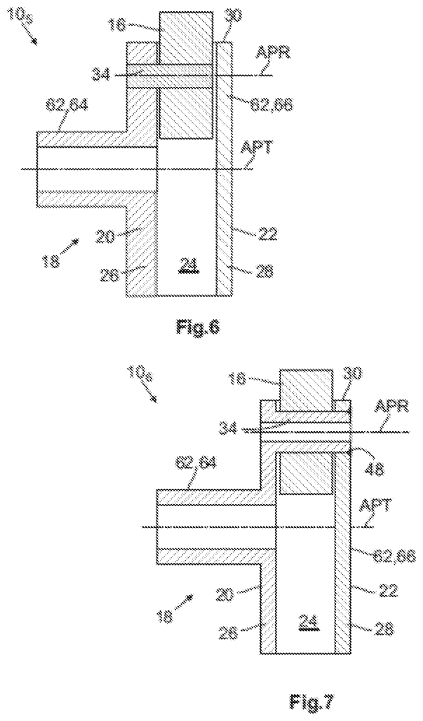

FIG. 6 a fifth exemplary embodiment of a planetary carrier arrangement according to the invention,

FIG. 7 a sixth exemplary embodiment of a planetary carrier arrangement according to the invention,

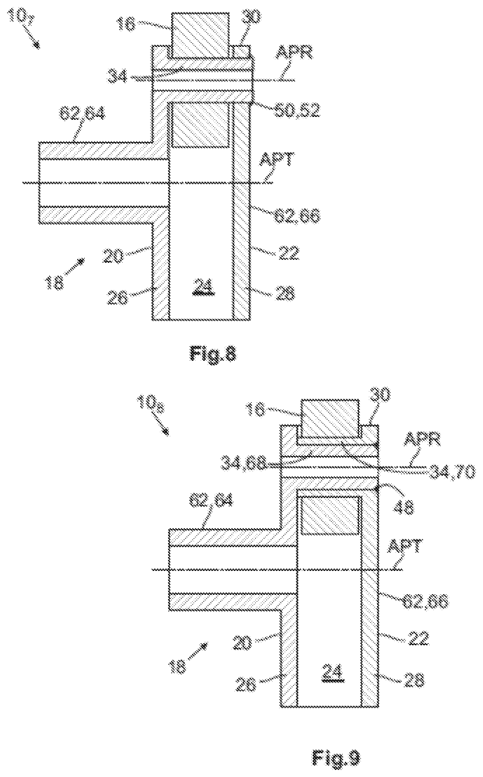

FIG. 8 a seventh exemplary embodiment of a planetary carrier arrangement according to the invention, and

FIG. 9 an eighth exemplary embodiment of a planetary carrier arrangement according to the invention, each by way of the sectional plane approximately defined in FIG. 1.

Eight different exemplary embodiments of a planetary carrier arrangement 10 according to the invention will be described in greater detail with reference to the FIGS. 1 to 9.

The same, or functionally the same parts, are given the same reference numerals in the different exemplary embodiments.

FIG. 1 serves to describe the basic design of the planetary carrier arrangement 10, and as such it is not directly associated with any of the exemplary embodiments, even if it is similar to the third exemplary embodiment of the planetary carrier arrangement 10₃ shown in FIG. 4.

The planetary carrier arrangement 10₁ shown in FIG. 1 comprises a planetary carrier 12, a drive shaft 14 and four planetary wheels 16. The planetary carrier 12 comprises a flange 18, which partially surrounds the drive shaft 14 along a rotational axis APT.

As is apparent from FIG. 2A, the planetary carrier 12 is formed rotationally symmetrical around the rotational axis APT, and the flange 18 is provided with a first side 20 and a second side 22. A recess 24 is disposed between the first side 20 and the second side 22. The first side 20 forms a first wall 26 in flange 18 and the second side 22 forms a second wall 28 in flange 18, which delimit the recess 24 laterally along the rotational axis APT.

Four recesses 24 are formed or machined into the planetary carrier 12, each of which is accessible, circumferentially symmetrical, from an outer shell surface 30 and which extend between the first wall 26 and the second wall 28.

Moreover, the first side 20, or the first wall 26 respectively, and the second side 22 or second wall 28 are provided with four openings 32 that are evenly distributed over the circumference, wherein said openings 32 connect the respective first side 20 and the second side 22 with the recess 24. The openings 32 are arranged around the circumference, centered to the respective recess 24.

One of the planetary wheels 16 is inserted into each recess 24 respectively, wherein said planetary wheel 16 protrudes in part beyond the shell surface 30 of the flange 18, and is rotatably retained by means of a planetary wheel axle 34 in the recess 24 around a planetary wheel rotational axis APR. The planetary wheels 16 are adapted with respect to the planetary wheel rotational axis APR to the size of the recess 24. Each of the planetary wheels 16 is provided with a through bore 36 along the planetary wheel rotational axis APR (see FIG. 2C), through each of which a planetary wheel axle 34 is pushed and rotatably supports the planetary wheel 16. Accordingly, one opening 32, one planetary wheel axle 34 and one planetary wheel 16 each are coaxially aligned to a planetary wheel rotational axis APR, wherein the planetary wheel rotational axis APR is disposed parallel to and at a distance from the rotational axis APR. In this instance the recesses are sized in such a way that the planetary carriers 12 [sic] are freely rotatable in the recess 24 around the respective planetary wheel axle 34.

In the first exemplary embodiment of the planetary carrier arrangement 10₁, shown in FIG. 2A, the planetary carrier 12 and the planetary wheel 16 are made from plastic and the planetary wheel axle 34 is made from steel. The assembly steps are now described with reference to FIGS. 2B and 2C. FIG. 2B depicts a view seen from the recess 24 to the first wall 26 of the planetary carrier 12, wherein the second wall 28 may be designed in exactly the same way. It is apparent that a pocket 38 in form of a depression is disposed in the first wall 26, which extends from the outer shell surface 30 radially inwards to the rotational axis APT to the extent that they enclose the openings 32. FIG. 2C clearly shows that the planetary wheel 16 has at its front sides each a protrusion 40, the diameter of which corresponds to the width of the pocket 38. At the closed inner end, the pocket 38 is provided with a semicircular section 42, the diameter of which also corresponds to the diameter of the protrusion. The semicircular section 42 is disposed concentrically to the opening 32 and therefore also to the planetary wheel rotational axis APR. For assembly purposes the planetary wheel 16 is inserted from outside radially into the recess 24 and the pocket 38 until the protrusion 40 comes to rest against the semicircular section 42. The planetary wheel 16 is the arranged concentrically to the opening 32 of the planetary carrier 12 so that the planetary wheel axle 34 can be inserted into the opening 32 of the planetary carrier 12 and through the through bore 36 of the planetary wheel 16. In the first exemplary embodiment, the planetary wheel axle 34 is pressed from the first side 20 into the planetary carrier 12 in such a way that the planetary wheel axle 34 has fully penetrated the planetary wheel 16 and the opening 32 and is accessible from the second side 22. The planetary wheel axle 34 is then caulked from the second side 22. Depending on the tooling arrangement, the planetary carrier 12 is rotated after being pressed in and prior to caulking. The planetary wheel 16 is now pivot-mounted in planetary carrier 12. Pressing in from the second side 22 and caulking from the first side 20 is also possible.

It is apparent from FIG. 2C that the planetary carrier arrangement 10₁ comprises a bund 44, which in this instance is designed as a thrust washer 46. Said thrust washer 46 is pushed onto protrusion 40 of the planetary wheel 16. The planetary wheel 16 runs up against the bund 44 of planetary carrier 12. The material of bund 44 is sized such that there is minimal friction and thus a small amount of wear at the contact point between the planetary wheel 16 and the planetary carrier 12.

The second exemplary embodiment of the planetary carrier arrangement 10₂, shown in FIG. 3, is only slightly different in design compared to the planetary carrier arrangement 10₁ of the first exemplary embodiment. In this instance not only the planetary carrier 12 and the planetary wheel 16 are made from plastic but also the planetary wheel axle 34. This makes it possible to pursue a somewhat different assembly process. As with the planetary wheel axle 34 made from steel, the planetary wheel axle 34 made from plastic is pressed from the first side 20 into the planetary carrier 12 until the planetary wheel axle 34 is flush with the first side 20, as shown in FIG. 3. The planetary wheel axle 34 is then ultrasonically welded from the first side 20 to the planetary carrier 12 62 [sic], producing a welding seam 48. Pressing in and welding can also be carried out from the second side 20 [sic] 22 (not shown).

In the third exemplary embodiment of the planetary carrier arrangement 10₃, shown in FIG. 4, the planetary carrier 12, the planetary wheel 16 and the planetary wheel axle 34 are also made from plastic. The planetary wheel axle 34 is provided in this exemplary embodiment with locking means 50, which are designed as elastic projections 52 that are disposed at both ends. During the passage through the openings 32 and the through bores 36, the projections 52 are moved inwards, and particularly once they have passed through the openings 32 they will return into their initial position. The planetary wheel axle 34 is thus fastened in the planetary carrier 12 without requiring any further measures.

A fourth exemplary embodiment of the planetary carrier arrangement 10₄ is shown in FIG. 5A. In this exemplary embodiment the planetary carrier 12, which is made from plastic, forms a first deformation 54 on the first wall 26 and a second deformation 56 on the second wall 28, both of which protrude into the recess 24. The planetary wheel 16 is pivot-mounted around both deformations 54, 56, so that, in this exemplary embodiment the deformations 54, 56 assume the function of the planetary wheel axle 34. For assembly purposes the planetary wheel 16 is inserted, as in the above-described exemplary embodiments, with a radially inwards-directed movement towards the rotational axis APT of the planetary carrier 12, into the recess 24 until the planetary wheel 16 has reached the desired position. Using a suitable tool, the planetary carrier 12 is then pressed from the first side 20 and from the second side 22 in the direction of the recess 24 into the through bore 36 of the planetary wheel 16, which produces the two deformations 54, 56.

FIG. 5B depicts the section marked X in FIG. 5A of the planetary carrier 12 prior to the pressing action. It is apparent that the planetary carrier 12 is provided with a first material buildup 58 on the first side 20 and a second material buildup 60 on the second side 22. The pressing action takes place in the section of the first and the second material buildup 58, 60, which provides a sufficient amount of material for the first and the second deformation 54, 56.

A fifth exemplary embodiment of the planetary carrier arrangement 10₅ according to the invention is shown in FIG. 6. In contrast to the previously described exemplary embodiments, the planetary carrier arrangement 10₅ in this exemplary embodiment is provided with a two-part planetary carrier 62 with a flange-like cage 64 and a cover 66, which may be fastened to the cage 64. In the fifth exemplary embodiment, the planetary wheel axle 34 is made from steel, whereas the planetary wheel 16, the cage 64 and the cover 66 are made from plastic. The cage 64 is produced through overmolding the planetary wheel axle 34 with plastic. This causes the planetary wheel axle 34 to be solidly anchored inside cage 64. The planetary wheel 16 is then pushed onto the planetary wheel axle 34 and the cover 66 is joined to the cage 64 or to the planetary wheel axle 34. To this end the cover 66 may be provided with the already mentioned locking means 50, which engage with the axle of the planetary wheel 16 or with the cage 64 (not shown).

A sixth exemplary embodiment of the planetary carrier arrangement 10₆ according to the invention is shown in FIG. 7, in which the cage 64 is also made from plastic, forming the planetary wheel axle 34 at the same time. To that extent there is no separate planetary wheel axle 34 present. The planetary wheel 16 is pushed onto the planetary wheel axle 34 and then the cover 66 is fastened through ultrasonic welding to the planetary wheel axle 34, creating a weld seam 48. Alternatively, it is possible to fasten the cover 66 directly to the cage 64 (not shown).

In the seventh exemplary embodiment of the planetary carrier arrangement 10₇ according to the invention, shown in FIG. 8, the planetary wheel axle 34 is also formed by the cage 64, which is provided at its free end with the already described locking means 50. First, the planetary wheel 16 and then the cover 66 are pushed onto the planetary wheel axle 34 for assembly. When pushing the cover onto the planetary wheel axle 34, the cover 66 locks together with the planetary wheel axle 34. There are no further steps necessary to fasten the cover to the cage 64.

An eighth exemplary embodiment of the planetary carrier arrangement 10₈ according to the invention is shown in FIG. 9. The cage 64, the planetary wheel 16 and the cover 66 in this exemplary embodiment are also made from plastic. The planetary wheel axle 34 in this exemplary embodiment is provided with a first planetary wheel axel section 68, formed by cage 64, and a second planetary wheel axle section 70 formed by cover 66.

The internal diameter of the tube-like second planetary wheel axle section 70 corresponds approximately to the outer diameter of the first planetary wheel axel section 68, so that both planetary wheel axle sections 68, 70 can be joined to each other. In the joined state the second planetary wheel axle section 70 encloses the first planetary wheel axel section 68, although the reverse case is also possible.

The cage 64 is made from a first plastic material and the cover 66 is made from a second plastic material, both of which are chosen so that they can be ultrasonically welded together, which creates the weld seam 48 shown in FIG. 9 and fastens the cover 66 to cage 64. Fastening of the cover 66 through locking means 50 (not shown in FIG. 9) is also possible. The first plastic material is mainly chosen so as to provide the planetary carrier 62 with the desired rigidity and tensile strength, whilst the second plastic material is chosen such that it has gliding characteristics that match the planetary wheel 16. The first plastic material may, for example, be fiber-reinforced. As a result, the planetary carrier arrangement 10₈ according to the eighth exemplary embodiment exhibits on the one hand great strength and on the other hand good gliding characteristics.

List of Reference Numerals

10 Planetary carrier arrangement

10₁ to 10₈ Planetary carrier arrangement

12 One-piece planetary carrier

14 Drive shaft

16 Planetary wheel

18 Flange

20 First side

22 Second side

24 Recess

26 First wall

28 Second wall

30 Shell surface

32 Opening

34 Planetary wheel axle

36 Through bore

38 Pocket

40 Protrusion

42 Semicircular section

44 Bund

46 Thrust washer

48 Weld seam

50 Locking means

52 Projection

54 First deformation

56 Second deformation

58 First material buildup

60 Second material buildup

62 Two-part planetary carrier

64 Cage

66 Cover

68 First planetary wheel axle section

70 Second planetary wheel axle section

APT Rotational axis

APR Planetary wheel rotational axis

What is claimed is:

1. A planetary carrier arrangement of a planetary gear, in particular a planetary gear of a side door drive, comprising
a planetary carrier (12), preferably in one-piece, with a flange (18) that extends along a rotational axis (APT) and which is provided with a first side (20) and a second side (22),
at least one planetary wheel (16), which is retained at a distance from the pivoting axis (APT) and is pivot-mounted around a planetary wheel rotational axis (APR), wherein
at least one recess (24) is arranged between the first side (20) and the second side (22), in which the at least one planetary wheel (16) is pivotally mounted and retained by means of at least one planetary wheel axle (34), characterized in that the planetary carrier (10) and the planetary wheel (16) are made from plastic and the planetary wheel axle (34) is made from steel.

2. The planetary carrier arrangement according to claim 1, characterized in that the planetary wheel axle (34) is pressed into the planetary carrier (10) on the first side (20) and is caulked with the planetary carrier (10) on the second side (22), or reverse.

3. A method for the manufacture of a planetary carrier arrangement according to claim 2, comprising the following steps
placing the at least one planetary wheel (16) into the recess (24),
pressing the planetary wheel axle (34) into the planetary carrier (10) from the first side (20) so that the planetary wheel axle (34) penetrates the planetary wheel (16) and the recess (24) and is accessible from the second side (22), and
caulking of the planetary wheel axle (34) from the second side (22).

4. The planetary carrier arrangement of a planetary gear, in particular a planetary gear of a side door drive, comprising
a planetary carrier (12), preferably in one piece, with a flange (18) that extends along a rotational axis (APT) and which has a first side (20) and a second side (22),
at least one planetary wheel (16), which is retained at a distance from the pivoting axis (APT) and is pivot-mounted around a planetary wheel rotational axis (APR), wherein
at least one recess (24) is arranged between the first side (20) and the second side (22), in which the at least one planetary wheel (16) is pivotally mounted and retained by means of at least one planetary wheel axle (34), characterized in that the planetary carrier (10), the planetary wheel (16) and the planetary wheel axle (34) are made from plastic.

5. The planetary carrier arrangement according to claim 4, characterized in that the planetary wheel axle (34) may be pressed on the first side (20) into the planetary carrier (10) and ultrasonically welded to the planetary carrier (10) from the first side (20).

6. The planetary carrier arrangement according to claim 4, characterized in that the planetary wheel axle (34) is provided with at least one locking means (50) with which the planetary wheel axle (34) is retained on the planetary carrier (10).

7. The method for the manufacture of a planetary carrier arrangement (10) according to claim 5, comprising the following steps
placing the at least one planetary wheel (16) into the recess (24),
pressing the planetary wheel axle (34) from the first side (20) so that the planetary wheel axle (34) penetrates the planetary wheel (16) and the recess (24), and
ultrasonic welding of the planetary wheel axle (34) to the planetary carrier (10) from the first side (20).

8. The method for the manufacture of a planetary carrier arrangement according to claim 6, comprising the following steps
placing the at least one planetary wheel (16) into the recess (24),
pressing the planetary wheel axle (34) from the first side (20) so that the planetary wheel axle (34) penetrates the planetary wheel (16) and the recess (24), and
interlocking the planetary wheel axle (34) with the planetary carrier (10).

9. A planetary carrier arrangement of a planetary gear, in particular a planetary gear of a side door drive, comprising
a planetary carrier (12), preferably in one piece, with a flange (18) that extends along a rotational axis (APT) and which has a first side (20) and a second side (22),
at least one planetary wheel (16), which is retained at a distance from the pivoting axis (APT) and is pivot-mounted around a planetary wheel rotational axis (APR), wherein
at least one recess (24) is arranged between the first side (20) and the second side (22), in which the at least one planetary wheel (16) is pivotally mounted and retained, characterized in that
the planetary carrier (10) and the planetary wheel (16) are made from plastic,
on the first side (20), at least a first deformation (54) and on the second side (22), at least a second deformation (56) is provided, which protrude into the recess (24), and
the planetary wheel (16) is retained by the first deformation (54) and the second deformation (56) in a pivotable manner.

10. The method for the manufacture of a planetary carrier arrangement according to claim 9, comprising the following steps
inserting the at least one planetary wheel (16) into the recess (24),
developing the first deformation (54) through deformation of the planetary carrier (12) on the first side (20), and
developing the second deformation (56) through deformation of the planetary carrier (12) on the second side (22).

11. The method according to claim 10, characterized in that
the planetary carrier (10) shows, on the first side (20), a first material buildup (58) and, on the second side (22), a second material buildup (60), and
the step of forming the first deformation (54) is carried out through deforming the planetary carrier (12) in the vicinity of the first material buildup (58), and
the step of forming the second deformation (56) is carried out through deforming the planetary carrier (12) in the vicinity of the second material buildup (60).

12. The planetary carrier arrangement according to claim 1, characterized in that the planetary carrier (10) is provided with pockets (38) on the first side (20) and/or on the second side (22) into which the planetary wheels (16) with corresponding protrusions (40) may be placed.

13. The planetary carrier arrangement according to claim 12, characterized in that the planetary carrier (12) comprises a bund (44) against which the planetary wheel axle (34) or the planetary wheel (16) runs up.

14. A planetary carrier arrangement of a planetary gear, in particular a planetary gear of a side door drive, comprising
a planetary carrier (62), preferably in two parts, with
a flange-like cage (64) that extends along a rotational axis (APT), and
a cover (66) that is attached to the cage (64) and thereby forming a recess (24),
at least one planetary wheel (16), which is retained at a distance from the pivoting axis (APT) and is pivot-mounted in the recess (24) around a planetary wheel rotational axis (APR), characterized in that the cage (64), the cover (66) and the planetary wheel (16) are made from plastic and the planetary wheel axle (34) is made from steel.

15. The method for the manufacture of a planetary carrier arrangement according to claim 14, comprising the following steps
providing the cage (64) through overmolding of the planetary wheel axle (34),
pushing the planetary wheel (16) onto the planetary wheel axle (34), and
fastening the cover (66) to the cage (64) or to the planetary wheel axle (34).

16. A planetary carrier arrangement of a planetary gear, in particular a planetary gear of a side door drive, comprising
a planetary carrier (62), preferably in two parts, with
a flange-like cage (64) that extends along a rotational axis (APT), and
a cover (66) fastened to the cage (64) and thereby forming a recess (24),
at least one planetary wheel (16), which is retained at a distance from the pivoting axis (APT) by means of a planetary wheel axle (34) and is pivot-mounted in the recess (24) around a planetary wheel rotational axis (APR), characterized in that the cage (64), the cover (66) and the planetary wheel (16) and the planetary wheel axle (34) are made from plastic, and the planetary wheel axle (34) is formed from the cage (64) or from the cover (66).

17. The method for the manufacture of a planetary carrier arrangement according to claim 16, comprising the following steps
providing the cage (64) that forms the planetary wheel axle (34),
pushing the planetary wheel (16) onto the planetary wheel axle (34), and
fastening the cover (66) to the cage (64) or to the planetary wheel axle (34).

18. A planetary carrier arrangement of a planetary gear, in particular a planetary gear of a side door drive, comprising
a planetary carrier (12), preferably in two parts, with
a flange-like cage (64) that extends along a rotational axis (APT), and
a cover (66) fastened to the cage (64) and thereby forming a recess (24),
at least one planetary wheel (16), which is retained at a distance from the pivoting axis (APT) by means of a planetary wheel axle (34) and is pivot-mounted in the recess (24) around a planetary wheel rotational axis (APR), characterized in that the cage (64), the cover (66) and the planetary wheel (16) and the planetary wheel axle (34) are made from plastic, and the planetary wheel axle (34) is provided with a first planetary wheel axle section (68) formed by the cage (64), and a second planetary wheel axle section (70) formed by the cover (66), which may be joined to each other.

19. The planetary carrier arrangement according to claim 18, characterized in that the cage (64) consists of a first plastic material and the cover (66) consists of a second plastic material.

20. The method for the manufacture of a planetary carrier arrangement according to claim 18, comprising the following steps
providing the cage (64) that forms the first planetary wheel axle section (68),
providing the cover (66) that forms the second planetary wheel axle section (70),
joining of the first planetary wheel axle section (68) and the second planetary wheel axle section (70) to each other,
pushing the planetary wheels (16) onto the first planetary wheel axle section (68) or onto the second planetary wheel axle section (70), and
fastening the cover (66) to the cage (64) or to the planetary wheel axles.

21. The method according to claim 15, in which the cover (66), the cage (64) and/or the planetary wheel axles are provided with locking means (50) with which the cover (66) is fastened to the planetary wheel axles or to the cage (64) through interlocking.

22. The method according to claim 17, in which the cover (66) is fastened to the planetary wheel axles or the cage (64) by means of ultrasonic welding.
